(19) United States
(12) Patent Application Publication
(10) Pub. No.: US 2026/0322220 A1
(43) Pub. Date: Oct. 15, 2026

(54) SHORT CIRCUIT DETECTION DEVICE AND SHORT CIRCUIT DETECTION METHOD FOR ROTATING ELECTRIC MACHINE

(71) Applicant: Mitsubishi Generator Co., Ltd., Kobe City, Hyogo (JP)

(72) Inventor: Yuji TAKIZAWA, Chiyoda-ku, Tokyo (JP)

(73) Assignee: Mitsubishi Generator Co., Ltd., Kobe City, Hyogo (JP)

(21) Appl. No.: 19/104,790

(22) PCT Filed: Oct. 26, 2022
(86) PCT No.: PCT/JP2022/039884

§ 371 Date: Feb. 19, 2025

(51) Int. Cl. H02K 11/20

(52) U.S. Cl. CPC H02K 11/20

(57) ABSTRACT

A short circuit detection device of a rotary electric machine includes a signal acquisition circuitry, a signal decomposition circuitry, and a short circuit detection circuitry, and detects a short circuit in a stator core. The signal decomposition circuitry decomposes a voltage signal from the signal acquisition into a plurality of frequency components of different orders. The short circuit detection circuitry compares an amplitude change of a low-order harmonic component of odd-order with the amplitude change of a first-order frequency component from the output result of the signal decomposition-based on two units of voltage signals acquired at different times, and determines whether the stator core is short circuited.

### TECHNICAL FIELD

The present disclosure relates to a short circuit detection device and short circuit detection method for rotating electric machine

### BACKGROUND ART

In the stator core of the rotating electric machine using a laminated core, a short circuit may occur between the laminations via an axial fastener. If a large short circuit current flows between the laminations of the stator core, in addition to an increase in heat loss, problems such as increased vibration of the rotating electric machine or an imbalance in the three-phase current output by the rotating electric machine may occur.

In particular, when the rotating electric machine is operated under high load, the magnetic flux density in the rotating electric machine is high, and if a short circuit occurs between the laminations of the stator core, the balance of each frequency component of the magnetic flux density changes significantly.

In the conventional technology described in Patent Document 1, a rotating electric machine in which a rotor holding a field winding and a stator are separated by a gap is provided with a device for monitoring the field magnetic flux in the gap and a device for detecting the presence of even harmonics of this magnetic flux wave. Then, a fault in the rotating electric machine is detected by detecting the even harmonics of the voltage induced in a search coil placed in the gap.

Furthermore, the conventional technology described in Patent Document 2 states that when the magnetic flux generated in the rotating electric machine is affected by magnetic saturation, odd-order harmonic currents flow through the stator windings, and the magnetic field created by these currents creates harmonic magnetic flux within the rotating electric machine. It also states that improvements of the stator core structure can suppress the generation of harmonic currents caused by magnetic saturation, thereby reducing the vibration and electromagnetic noise of the rotating electric machine.

### CITATION LIST

### Patent Document

Patent Document 1: Japanese Laid-Open Patent Publication No. S53-84101
Patent Document 2: Japanese Laid-Open Patent Publication No. 2010-130839

### SUMMARY OF THE INVENTION

### Problem to be Solved by the Invention

The conventional technology described in Patent Document 1 can detect short circuits in the rotor field winding by detecting even harmonics of the voltage induced in the search coil, but does not detect short circuits between laminations of the stator core.

Also, the conventional technology described in Patent Document 2 reduces the adverse effects of magnetic saturation, but does not consider detecting short circuits between laminations of the stator core.

As a result, there is a problem in that even if a short circuit occurs between laminations of the stator core while the rotating electric machine is operating in a state where the magnetic flux density of the stator core is relatively high, the occurrence of the short circuit cannot be detected with high accuracy.

The present disclosure has been made to solve the above problem, and an object of the present disclosure is to provide the short circuit detection device and short circuit detection method for rotating electric machine that can accurately detect short circuits that occur between laminations of the stator core while the rotating electric machine is operating in a state where the magnetic flux density of the stator core is relatively high.

### Means to Solve the Problem

A short circuit detection device for a rotary electric machine according to the present disclosure comprising:
a signal acquisition unit acquiring a voltage signal from a magnetic detector arranged on a stator side facing a rotor of the rotary electric machine;
a signal decomposition unit decomposing the voltage signal into a plurality of frequency components of different orders; and
a short circuit detection unit determining a short circuit in a laminated stator core based on a low-order harmonic component of odd-order and a primary frequency component among the frequency component decomposed by the signal decomposition unit, wherein
the signal acquisition unit acquires the voltage signal with one electrical angle cycle as one unit;
the short circuit detection unit detects an amplitude change of the low-order harmonic component and the amplitude change of the primary frequency component based on two units of the voltage signal acquired at different times, and determines the short circuit in the stator core based on a comparison between the amplitude change of the low-order harmonic component and the amplitude change of the primary frequency component.

A method for detecting short circuit in a rotary electric machine according to the present disclosure comprising:
a signal acquisition step for acquiring a voltage signal from a magnetic detector arranged on a stator side facing a rotor of the rotary electric machine;
a signal decomposition step for decomposing the voltage signal into a plurality of frequency components of different orders; and
a short circuit detection step for determining a short circuit in a laminated stator core based on a low-order harmonic component of odd-order and a primary frequency component among the frequency component decomposed in the signal decomposition step, wherein
the signal acquisition step acquires the voltage signal with one electrical angle cycle as one unit, and the short circuit detection step detects an amplitude change of the low-order harmonic component and the amplitude change of the primary frequency component based on two units of the voltage signal acquired at different times, and determines the short circuit in the stator core based on a comparison between the amplitude change of the low-order harmonic component and the amplitude change of the primary frequency component.

### Effect of the Invention

According to the short circuit detection device and short circuit detection method for rotating electric machine, a short circuit occurring between laminations in the stator core can be accurately detected while the rotating electric machine is operating in a state in which the magnetic flux density of the stator core is relatively high.

### BRIEF DESCRIPTION OF THE DRAWINGS

FIG. 1 is a block diagram showing a rotary electric machine and a short circuit detection device according to a embodiment 1.

FIG. 2 is a waveform diagram showing a voltage signal when the machine is in a healthy state, acquired by a signal acquisition unit according to the embodiment 1.

FIG. 3 is a waveform diagram showing a voltage signal when the machine is in a short circuit, acquired by a signal acquisition unit according to the embodiment 1.

FIG. 4 is a diagram showing a magnetic flux density distribution when the stator core is short-circuited, according to the embodiment 1.

FIG. 5 is a spectrum diagram showing the amplitudes of odd-order components when the machine is in a healthy state and when the stator core is short-circuited, among the frequency components resolved by a signal resolution unit according to the embodiment 1.

FIG. 6 is a diagram showing the amplitude ratios of the frequency components calculated by a short circuit detection unit according to the embodiment 1.

FIG. 7 is a diagram showing a flowchart for explaining a short circuit detection method according to the embodiment 1.

FIG. 8 is a block diagram showing an example of hardware for realizing each function of a signal processing device according to the embodiment 1.

FIG. 9 is a block diagram showing another example of hardware for realizing each function of a signal processing device according to the first embodiment.

FIG. 10 is a diagram showing the amount of change in amplitude of each frequency component calculated by the short circuit detection unit according to embodiment 2.

FIG. 11 is a diagram showing the differential signal of two different voltage signals acquired by the signal acquisition unit according to embodiment 3.

FIG. 12 is a spectral diagram showing the amplitude ratio of each frequency component calculated by the short circuit detection unit according to embodiment 3.

### DESCRIPTION OF EMBODIMENTS

### Embodiment 1

Hereinafter, embodiment of the present disclosure will be described with reference to the drawings.

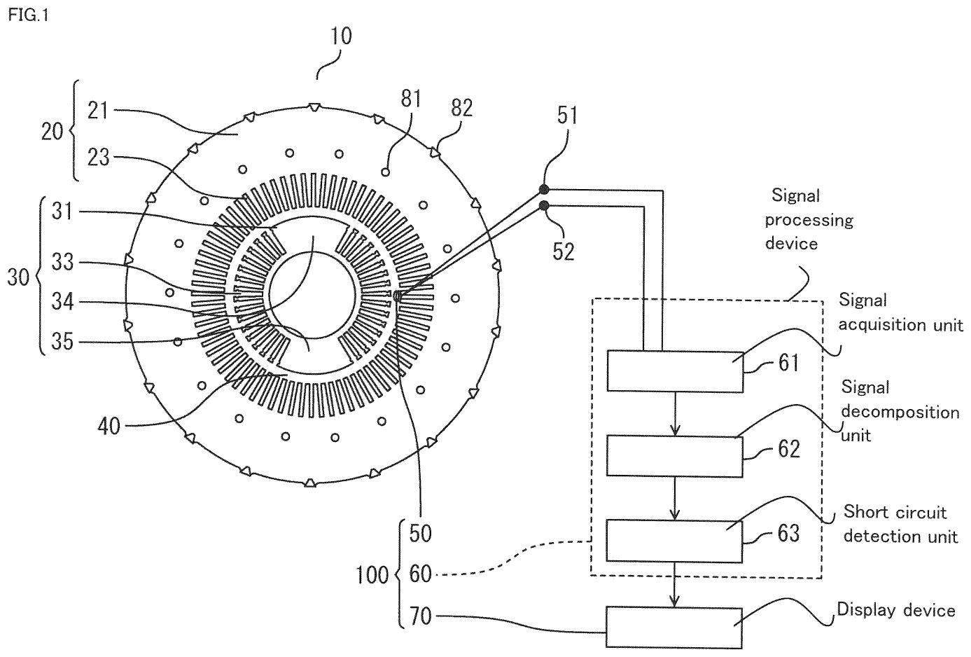

FIG. 1 is a block diagram showing a rotary electric machine and a short circuit detection device according to embodiment 1. In embodiment 1, a turbine generator 10 is used as the rotary electric machine. In FIG. 1, a cross section perpendicular to the axial direction of the turbine generator 10 is shown.

As shown in FIG. 1, the turbine generator 10 has a stator 20 as an armature and a rotor 30 as a field magnet. The stator 20 is provided on the outside of the rotor 30.

The stator 20 has a cylindrical stator core 21 and a multi-phase winding 22 (not shown), and a plurality of stator slots 23 formed at the inner periphery of the stator core 21.

The axial direction of the stator core 21 is along the axis of the stator core 21 and perpendicular to the paper surface of FIG. 1. The radial direction of the stator core 21 is the radial direction of a circle centered on the axis of the stator core 21. The circumferential direction of the stator core 21 is the direction along an arc centered on the axis of the stator core 21.

Each stator slot 23 formed at the inner circumference of the stator core 21 is provided along the radial direction of the stator core 21. The multiple stator slots 23 are arranged at equal pitches in the circumferential direction of the stator core 21. Multi-phase windings 22 are wound in the multiple stator slots 23.

The stator core 21 has a laminated structure formed by stacking steel plates, and fasteners 81 and 82 are provided on the inside and outer periphery of the stator core 21, and the fasteners 81 and 82 each penetrate the stator core 21 to hold the laminated stator core 21.

The rotor 30 has a rotor core 31, a field winding 32 (not shown), and a rotating shaft (not shown). The rotor core 31 and the rotating shaft are arranged coaxially with the stator core 21. The rotor 30 can rotate around the rotating shaft.

A plurality of rotor slots 33 are formed on the outer periphery of the rotor core 31. Each rotor slot 33 is formed along the radial direction of the rotor core 31. In this case, the rotor slots 33 are divided into two slot groups, and a first magnetic pole 34 and a second magnetic pole 35 are formed between the two slot groups. In each slot group, the rotor slots 33 are arranged at equal pitches in the circumferential direction of the rotor core 31.

The field winding 32 is DC excited by an external power source (not shown). As a result, one of the first magnetic pole 34 and the second magnetic pole 35 becomes a north pole, and the other becomes a south pole. In other words, the turbine generator 10 is a two-pole generator.

A gap 40 is formed between the stator core 21 and the rotor core 31. The multi-phase windings 22 are AC excited by an external power source (not shown). This generates a rotating magnetic field in the air gap 40.

The short circuit detection device 100 detects short circuits between laminations of the stator core 21 of the turbine generator 10, and includes a search coil 50 as a magnetic detector, a signal processing device 60 that processes detection signals from the search coil 50, and a display device 70. The search coil 50 is disposed in the air gap 40 facing the rotor 30.

The search coil 50 may also be disposed inside the stator core 21, including the stator slot 23 adjacent to the air gap 40, facing the rotor 30. That is, the search coil 50 is disposed on the stator 20 side including the air gap 40, so as to face to the rotor 30.

The main magnetic flux and leakage magnetic flux are linked to the search coil 50. The main magnetic flux is the magnetic flux generated in the air gap 40, and the leakage magnetic flux is the magnetic flux leaking out from each rotor slot 33. The magnetic flux that links to the search coil 50 is called the linkage magnetic flux.

The search coil 50 has a first terminal 51 and a second terminal 52. When magnetic flux links to the search coil 50, a voltage signal that is a detection signal is induced between the first terminal 51 and the second terminal 52. The distribution of the linkage magnetic flux in the search coil 50 varies with the rotation of the rotor 30.

In this case, the short circuit detection device 100 is equipped with the search coil 50 as a magnetic detector, but the search coil 50 may be configured separately from the short circuit detection device 100.

The signal processing device 60 has, as its functional blocks, a signal acquisition unit 61, a signal decomposition unit 62, and a short circuit detection unit 63. The signal acquisition unit 61 acquires the voltage signal induced in the search coil 50. The signal decomposition unit 62 decomposes the acquired voltage signal into a plurality of frequency components of different orders. The voltage signal acquired by the signal acquisition unit 61 is treated as one unit of one electrical angle cycle. The signal decomposition unit 62 decomposes the voltage signal for one electrical angle cycle into each frequency component. Furthermore, the signal decomposition unit 62 separates each of the decomposed frequency components into amplitude and phase.

The short circuit detection unit 63 analyzes the amplitude of the odd-order frequency components among the decomposed frequency components. The odd-order frequency components are composed of a fundamental wave component, which is a primary first-order component that oscillates once per electrical angle period corresponding to the two poles of the first magnetic pole 34 and the second magnetic pole 35, and third-order and higher harmonic components other than this first-order component. The short-circuit detection unit 63 determines a short circuit in the laminated stator core 21 based on the odd-order low-order harmonic components and the first-order component.

If there is no change in the operating state of the turbine generator 10 and no short circuit has occurred in the stator core 21, the amplitude of each odd-order frequency component resolved by the signal decomposition unit 62 remains unchanged.

Also, if there is no change in the operating state of the turbine generator 10, a short circuit has occurred in the stator core 21, and the short-circuit state remains constant, the amplitude of each odd-order frequency component resolved by the signal decomposition unit 62 remains unchanged.

On the other hand, even if there is no change in the operating state of the turbine generator 10, the amplitudes of the odd-order frequency components decomposed by the signal decomposition unit 62 will not be the same for the voltage signal for one electrical angle cycle acquired before the short circuit of the stator core 21 occurs and the voltage signal for one electrical angle cycle acquired after the short circuit occurs. In other words, when an amplitude change is observed between the two units of voltage signals in the odd-order frequency components obtained by frequency decomposing two units of voltage signals acquired one unit (one electrical angle cycle) at different times, a short circuit of the stator core 21 can be detected.

The voltage waveforms of the two units of voltage signals are acquired by the signal acquisition unit 61 continuously or intermittently at a time interval, one unit at a time. When an amplitude change is observed in the odd-order frequency components between the two units of voltage signals, the past voltage signal acquired before the short circuit occurs and the newly acquired voltage signal, a new short circuit of the stator core 21 can be detected.

The short circuit detection unit 63 calculates the amplitude ratio as the amplitude change of each odd-order frequency component of the voltage signal of two units in which the turbine generator 10 is in the same operating state. In this embodiment, when the amplitude ratio of the third-order component is greater than the amplitude ratio of the first-order component, the short circuit detection unit 63 detects that a short circuit has occurred in the stator core 21.

Furthermore, the short circuit detection unit 63 outputs information regarding the presence or absence of a short circuit in the stator core 21 to the display device 70.

The display device 70 is provided outside the signal processing device 60. The display device 70 displays the presence or absence of a short circuit in the stator core 21 based on the information from the short circuit detection unit 63. The display device 70 may be provided outside the short circuit detection device 100.

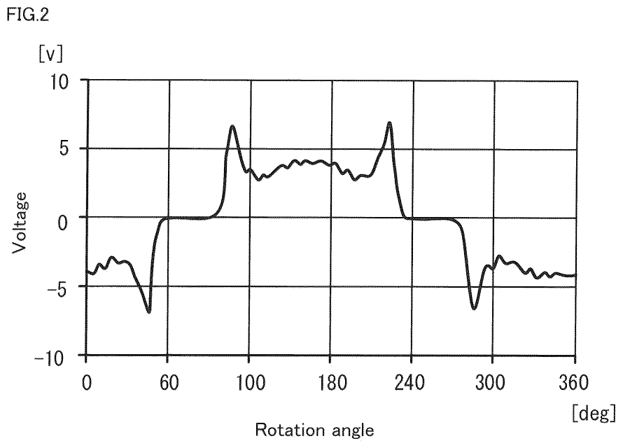

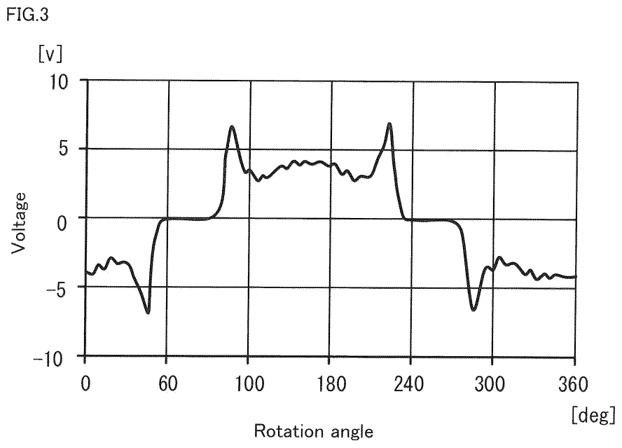

FIG. 2 is a waveform diagram showing a voltage signal acquired by the signal acquisition unit 61 when the device is operating normally. Also, FIG. 3 is a waveform diagram showing a voltage signal acquired by the signal acquisition unit 61 when a short circuit has occurred.

FIG. 2 and FIG. 3 show examples of voltage signals during normal operation and during a short circuit, with the horizontal axis corresponding to one period of electrical angle corresponding to the two poles, the first magnetic pole 34 and the second magnetic pole 35.

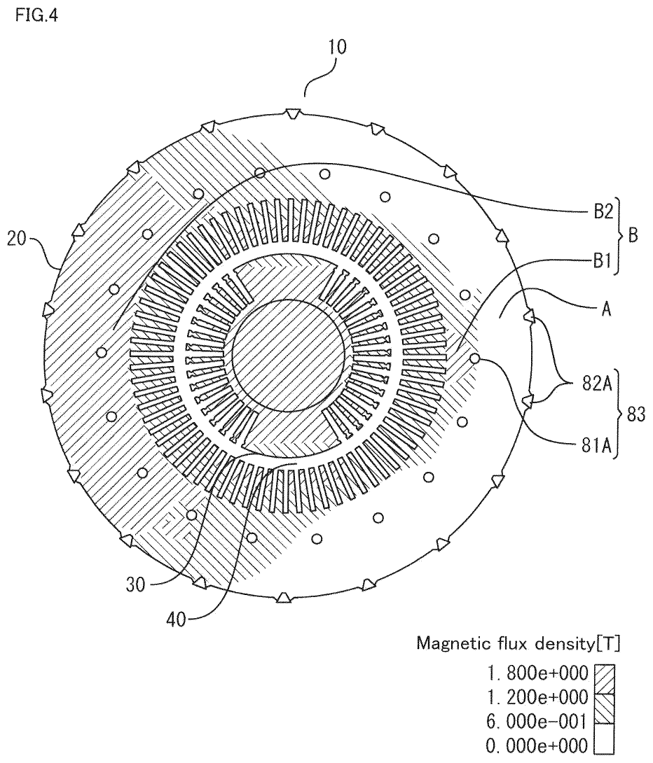

FIG. 4 shows the magnetic flux density distribution when the stator core 21 is short-circuited, and shows the magnetic flux density distribution at the time when the voltage signal in FIG. 3 was acquired.

FIG. 2 to FIG. 4 were obtained by simulating the no-load operating state in which the turbine generator 10 generates the rated voltage using an electromagnetic field analysis program.

The simulation during a short circuit is performed under the condition that the stator core 21 is short-circuited via a fastener 83 that penetrates and holds the stator core 21 inside or on the outer periphery of the stator core 21. In this case, the fastener 81A that is placed inside the stator core 21 at the same circumferential position as the search coil 50 shown in FIG. 1, and the fasteners 82A that are placed at circumferential positions on both sides of the fastener 81A on the outer periphery of the stator core 21, form the fasteners 83 that forms the short circuit.

When detecting a short circuit in the stator core 21, it is important to quickly detect when a large short circuit current flows between the laminations of the stator core 21 due to a short circuit. For this reason, the simulation of a short circuit was set under conditions where the fasteners 83 that make up the short circuit are close to each other and a large short circuit current is likely to flow.

In this example, the signal processing device 60 uses the voltage signal acquired by the signal acquisition unit 61 to estimate that a short circuit has occurred in the stator core 21. This is explained below.

Each voltage waveform shown in FIG. 2 and FIG. 3 is a voltage waveform for one electrical angle period, with circumferential angles from 0° to 180° corresponding to the first magnetic pole 34 and circumferential angles from 180° to 360° corresponding to the second magnetic pole 35. Therefore, at a circumferential angle of 90°, the center of the first magnetic pole 34 is closest to the search coil 50, and at a circumferential angle of 270°, the center of the second magnetic pole 35 is closest to the search coil 50.

The voltage waveform shown in FIG. 2 is a voltage waveform when there is no short circuit and the rotor is in a normal good condition, with 32 small voltage fluctuations occurring for each rotor slot pitch.

The voltage waveform shown in FIG. 3 is a voltage waveform when there is a short circuit and the amplitude of the harmonic components increases as described below, but from the perspective of the overall waveform, it is almost the same as FIG. 2.

As described above, the signal decomposition unit 62 decomposes the voltage signal acquired by the signal acquisition unit 61 into a plurality of frequency components of different orders, and further separates each of the decomposed frequency components into amplitude and phase.

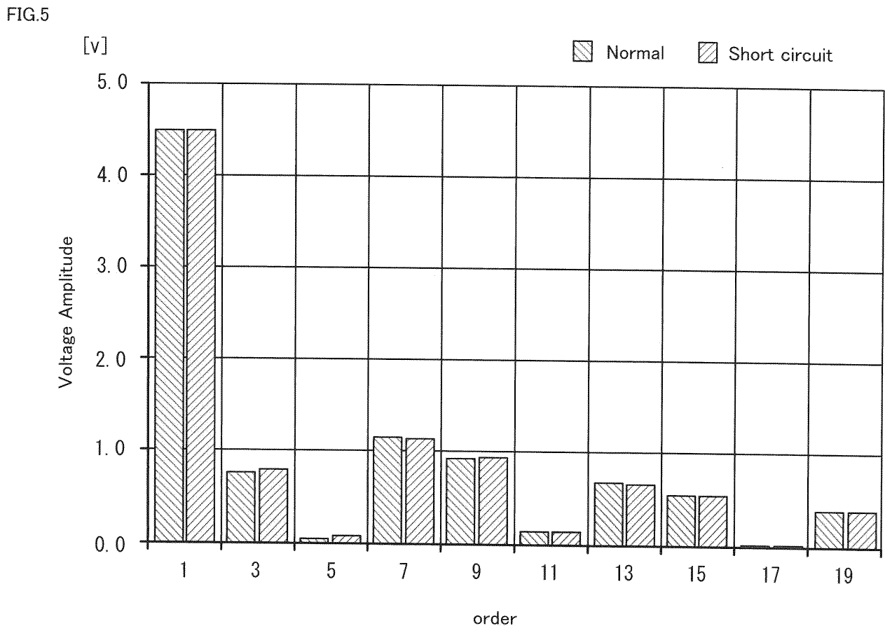

FIG. 5 is a spectrum diagram showing the amplitudes of odd-order components when the rotor is in a normal state and when there is a short circuit among the frequency components decomposed by the signal decomposition unit 62. That is, in FIG. 5, the amplitude spectrum of the odd-order components based on the voltage waveform shown in FIG. 2 and the amplitude spectrum of the odd-order components based on the voltage waveform shown in FIG. 3 are shown side by side for easy comparison of absolute values. Although there are orders of 21 and above, FIG. 5 shows orders of 19 and below for the sake of explanation.

The primary first order component is the fundamental wave component corresponding to the main magnetic flux among the magnetic flux generated in the air gap 40, and has the largest amplitude. The third and higher odd order components are harmonic components other than the main magnetic flux, and are caused by pulsation factors such as the number of slots in the rotor 30 or stator 20 among the magnetic flux generated in the air gap 40. When a short circuit occurs, it can be seen that the amplitude of the first order component hardly changes, but the amplitude of the third and fifth order components increases.

As shown in FIG. 4, in the area A surrounded by the fastener 81A and fastener 82A shorted to the stator core 21, the magnetic flux density decreases due to magnetic shielding. In contrast, in region B, which includes region B1 on the radial inside of region A and region B2 on the opposite side of region A with respect to the axis, the magnetic flux density increases due to the shielded and bypassed magnetic flux. The magnetic flux density in the center of the magnetically saturated region becomes high, and the magnetic flux density in the peripheral region also becomes high, widening the magnetically saturated region and increasing the harmonic components.

The bypassed magnetic flux makes a half-circle detour as in region B, and there are two or four spatial fluctuations on the core back side or teeth side in total, so it appears mainly as a third or fifth order change in low-order magnetic flux density, rather than a first-order or higher-order change in magnetic flux density. The effect of magnetic saturation also appears as a harmonic component of frequencies that are multiples of 2 or 4, but the higher the frequency, the smaller the voltage value becomes.

Basically, the permeance change is second order and the magnetomotive force change is first order, so the difference between them, the change in magnetic flux density, is third order. If the permeance change has a fourth-order harmonic component, the change in magnetic flux density will be third or fifth order. Similarly, harmonics of even higher frequencies will be included.

The short-circuit detection unit 63 calculates the amplitude ratio between the same lower orders of the odd-order harmonic components decomposed by the signal decomposition unit 62.

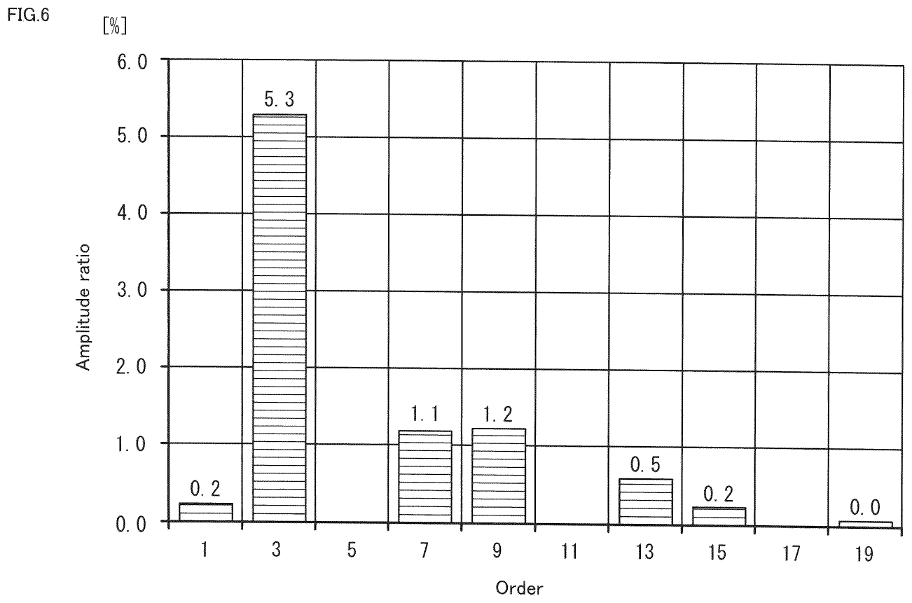

FIG. 6 is a diagram showing the amplitude ratio of each frequency component calculated by the short-circuit detection unit 63, and is the amplitude ratio calculated from the spectrum diagram of FIG. 5.

In FIG. 5, the fifth, eleventh, and seventeenth order components, which have relatively small absolute amplitude values, are excluded from the calculation because they have a poor SN ratio (signal to noise ratio) of the amplitude ratio.

For example, if one nth order amplitude value is Vin and the other nth order amplitude value is V2n, the amplitude ratio R is calculated as R=(|V1n−V2n|/V1n)×100, in %, as a percentage. The magnetic saturation region increases with a short circuit. When there is no short circuit, the amplitude ratio is almost 0, but when a short circuit occurs, the amplitude ratio changes. The first and seventh and higher order frequency components are relatively less affected by magnetic saturation and have small amplitude ratios. In contrast, the third and fifth order frequency components, which are low-order harmonic components, are characterized by being greatly affected by magnetic saturation due to a short circuit and having large amplitude ratios.

In this case, the fifth order component is excluded, and it can be seen that the amplitude ratio of the third order component is large. In general, the magnitude of the amplitude of the third order component and the fifth order component will be large and small, or both will be medium and balanced, depending on the phase of the two components.

As shown in FIG. 6, the amplitude ratio of the higher frequency components is 0.0 to 1.2%, while the amplitude ratio of the third-order component is about 5%, which is much greater than 1.2%. The amplitude ratio of the first-order component is a relatively small 0.2%, and the amplitude ratio of the third-order component is significantly greater than the amplitude ratio of the first-order component.

The short circuit detection unit 63 detects the occurrence of a short circuit in the stator core 21, for example, when the amplitude ratio of the third-order component is clearly greater than the amplitude ratio of the first-order component based on a comparison between the amplitude ratio of the first-order component and the amplitude ratio of the third-order component. The determination that the amplitude ratio is clearly greater may be made, for example, when the difference or ratio is greater than a set value.

By making the determination using the third-order component, which has the largest absolute value of the amplitude ratio due to the influence of magnetic saturation in the stator core 21, the signal-to-noise ratio of the amplitude ratio is good, and a short circuit can be determined with higher accuracy. In addition, when the stator core 21 is magnetically saturated, the amplitude of the harmonic components is larger than when it is not magnetically saturated, so the amplitude ratio of the harmonic components before and after a short circuit occurs in the stator core 21 can be analyzed with a good signal-to-noise ratio. For this reason, a state in which the turbine generator 10 is operated at a high magnetic flux density is suitable for detecting a short circuit in the stator core 21.

Next, the short circuit detection method according to this embodiment will be described below with reference to the drawings.

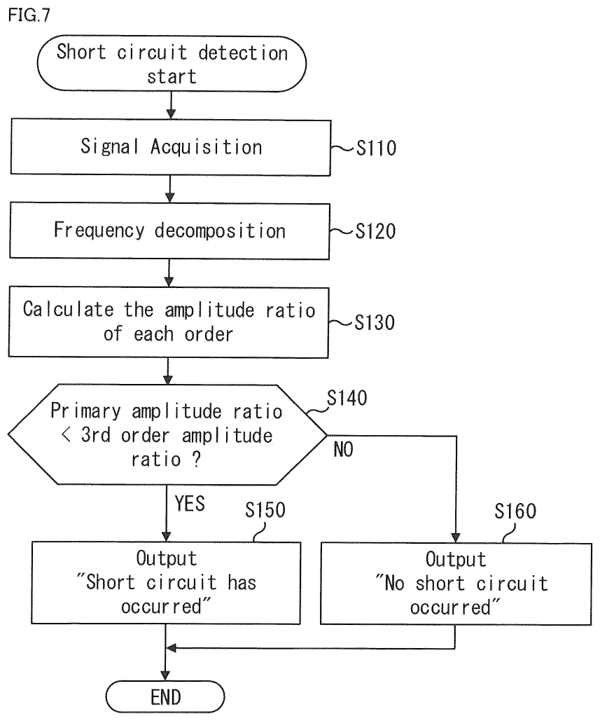

FIG. 7 is a diagram showing a flowchart explaining the short circuit detection method according to the embodiment 1. When the short circuit detection device 100 is started, the signal processing device 60 executes the short circuit detection routine shown in the flowchart of FIG. 7 at predetermined intervals.

When the short circuit detection routine is started, first, the signal acquisition unit 61 acquires one unit (one electrical angle cycle) of voltage signal from the search coil 50 (step S110).

Next, the signal decomposition unit 62 decomposes the acquired voltage signal into a plurality of frequency components of different orders and separates them into amplitude and phase (step S120).

Next, the short circuit detection unit 63 calculates the amplitude ratio of each odd-order frequency component from the results obtained in step S120 based on two units of voltage signals, the voltage signal acquired in the previous routine and the voltage signal acquired in the current routine (step S130).

The short circuit detection unit 63 then determines whether the amplitude ratio of the third-order component is greater than the amplitude ratio of the first-order component (step S140).

If the amplitude ratio of the third-order component is greater than the amplitude ratio of the first-order component in step S140, the short circuit detection unit 63 determines that a short circuit has occurred in the stator core 21, outputs information indicating “short circuit has occurred” to the display device 70, and ends the current routine (step S150).

If the result is NO in step S140, the short circuit detection unit 63 outputs information indicating “no short circuit has occurred” to the display device 70, and ends the current routine (step S160).

As described above, the short circuit detection method according to this embodiment includes a signal acquisition step shown in step S110, a signal decomposition step shown in step S120, and a short circuit detection step shown in steps S130 to S160.

In the signal acquisition step, a voltage signal of one unit (corresponding to one electrical angle cycle) is acquired from the search coil 50 arranged so as to face to the rotor 30. In the signal decomposition step, the voltage signal acquired in the signal acquisition step is decomposed into a plurality of frequency components of different orders.

In the short circuit detection step, the amplitude ratio of the odd-order low-order harmonic component (in this case, the third-order component) and the amplitude ratio of the first-order component are calculated from the amplitude of each order component obtained in the signal decomposition step based on the voltage signal in the previous routine and the voltage signal in the current routine, which are two units of voltage signals acquired at different times. Then, in the short circuit detection step, if the amplitude ratio of the third-order component is greater than the amplitude ratio of the first-order component, it is determined that a short circuit has occurred in the stator core 21. Furthermore, if the amplitude ratio of the first-order component is equal to or smaller than the amplitude ratio of the third-order component, it is determined that no short circuit has occurred in the stator core 21.

As described above, the short circuit detection device 100 according to this embodiment compares the amplitude ratio of the odd-order low-order harmonic components and the amplitude ratio of the first-order frequency component based on two units of voltage signals acquired at different times to determine a short circuit in the stator core 21. Therefore, the occurrence of a short circuit in the stator core 21 can be detected with high accuracy while the turbine generator 10 is operating with the magnetic flux density of the stator core 21 being relatively high.

Note that if the turbine generator 10 is operating with the magnetic flux density of the stator core 21 being low, it is difficult to detect the change in amplitude of the harmonic components before and after the occurrence of a short circuit in the stator core 21, and the accuracy of the short circuit detection deteriorates. In that case, the turbine generator 10 is operating at a low load, and even if a short circuit occurs between the laminations of the stator core 21, no large short circuit current will flow, and no problematic malfunction will occur.

The short circuit detection step in the above embodiment newly detects the occurrence of a short circuit in the stator core 21 based on the voltage signal acquired in the current routine. The other of the two units of voltage signals is not limited to the voltage signal acquired in the previous routine.

Also, since the stator core 21 and the fastener 83 are short-circuited through slight contact resistance, the contact portion may burn out with a slight short-circuit current, eliminating the short circuit. Since the short circuit detection device 100 detects the occurrence of a short circuit in the stator core 21 by capturing changes in two units of voltage signals acquired at different times, it is not necessarily the case that the voltage signal acquired later is the one at the time of the short circuit. A short circuit can be detected even if the voltage signal acquired earlier is the one at the time of the short circuit, and the voltage signal acquired after the short circuit is eliminated is the voltage signal for two units.

In the above embodiment, the short circuit detection unit 63 uses the third-order component as the odd-order low-order harmonic component, but if the amplitude ratio of at least one of the third-order and fifth-order components is greater than the amplitude ratio of the first-order component, it determines that a short circuit has occurred in the stator core 21. In this case, the third-order and fifth-order components, whichever has the greater amplitude ratio, may be compared with the amplitude ratio of the first-order component. In this embodiment, the third-order component, which has the largest absolute value of the amplitude due to the influence of magnetic saturation, is used for the determination, so that the signal-to-noise ratio of the amplitude ratio is good and a short circuit can be determined with higher accuracy.

In the above embodiment, the rotor 30 is disposed on the inner circumference side of the stator 20, but the rotor 30 may be disposed on the outer circumference side of the stator 20.

In the above embodiment, the turbine generator 10 is used as the rotary electric machine, but the rotary electric machine may be a generator other than the turbine generator 10, or may be an electric motor.

Furthermore, although a search coil 50 is used as a magnetic detector, but not limited to a magnetic detector.

The functions of the signal processing device 60 of embodiment 1 are realized by a processing circuit.

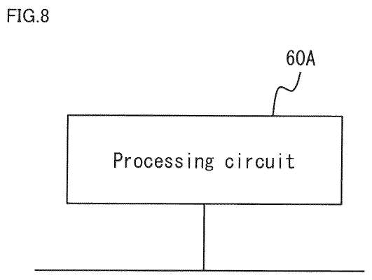

FIG. 8 is a configuration diagram showing an example of hardware that realizes each function of the signal processing device 60. In this case, the signal processing device 60 is configured with a processing circuit 60A, which is dedicated hardware.

The processing circuit 60A may be, for example, a single circuit, a composite circuit, a programmed processor, a parallel programmed processor, an ASIC (Application Specific Integrated Circuit), an FPGA (Field Programmable Gate Array), or a combination of these.

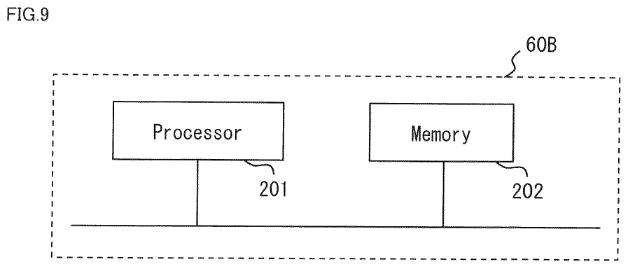

FIG. 9 is a configuration diagram showing another example of hardware that realizes each function of the signal processing device 60 according to embodiment 1. In this case, the processing circuit 60B includes a processor 201 and a memory 202.

In the processing circuit 60B, the functions of the signal processing device 60 are realized by software, firmware, or a combination of software and firmware. The software and firmware are written as programs and stored in the memory 202. The processor 201 realizes each function by reading and executing the programs stored in the memory 202.

It can also be said that the program stored in the memory 202 causes the computer to execute the procedures or methods of each part described above. In other words, this program is a short-circuit detection program, and is a program that causes the computer to execute signal acquisition processing, signal decomposition processing, and short-circuit detection processing.

Here, memory 202 refers to non-volatile or volatile semiconductor memory such as RAM (Random Access Memory), ROM (Read Only Memory), flash memory, EPROM (Erasable Programmable Read Only Memory), EEPROM (Electrically Erasable and Programmable Read Only Memory), etc. Also included in memory 202 are magnetic disks, flexible disks, optical disks, compact disks, mini disks, DVDs, etc.

The functions of the signal processing device 60 described above may be partially realized by dedicated hardware and partially realized by software or firmware.

In this way, the processing circuit can realize the functions of the signal processing device 60 described above by hardware, software, firmware, or a combination of these.

### Embodiment 2

In the above embodiment 1, the short circuit detection unit 63 uses the amplitude ratio as the amplitude change of each frequency component of two units of voltage signals acquired at different times, but the amplitude change amount itself may be used.

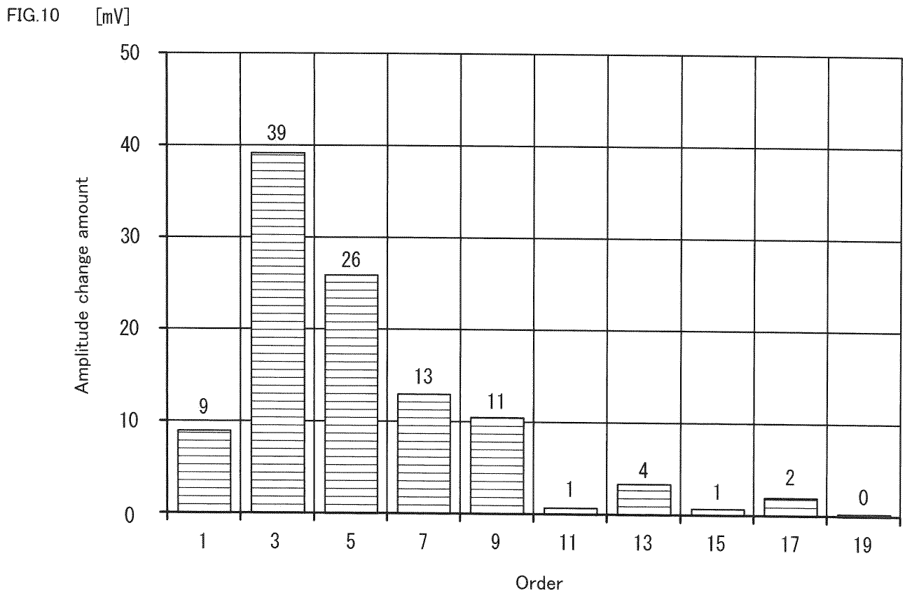

FIG. 10 is a diagram showing the amplitude change amount of each frequency component calculated by the short circuit detection unit 63.

If one nth order amplitude value is Vin and the other nth order amplitude value is V2n, the amplitude change amount ΔV is calculated as ΔV=|V1n−V2n|.

As shown in FIG. 10, the amplitude change of the odd-order low harmonic components, the 3rd and 5th order components, is large and significantly larger than the amplitude change of the first-order component. In particular, the amplitude change of the third-order component is large. Furthermore, the amplitude change of the seventh and higher order harmonic components is small, showing the same tendency as in FIG. 6 of the above embodiment 1 using the amplitude ratio.

The short circuit detection unit 63 then detects the occurrence of a short circuit in the stator core 21 based on a comparison between the amplitude change of the first-order component and the amplitude change of the third-order component, for example, when the amplitude change of the 3rd order component is clearly larger than the amplitude change of the first-order component.

As described above, in this embodiment, the amplitude change of the odd-order low harmonic components is compared with the amplitude change of the first-order frequency component based on two units of voltage signals acquired at different times to determine whether the stator core 21 is short circuited. Therefore, as in the above-mentioned embodiment 1, the occurrence of a short circuit in the stator core 21 can be accurately detected during operation of the turbine generator 10 in a state in which the magnetic flux density of the stator core 21 is relatively high.

Furthermore, since the amount of change in amplitude is used to determine whether or not a short circuit has occurred, the magnitude of the absolute amplitude value does not affect the S/N ratio. Therefore, a short circuit can be accurately detected without removing order components with small absolute amplitude values.

### Embodiment 3

In the above-mentioned embodiments 1 and 2, the signal decomposition unit 62 decomposed the voltage signal acquired by the signal acquisition unit 61 into each frequency component, and the short circuit detection unit 63 performed short circuit detection based on the results of the decomposition of two units of voltage signals by the signal decomposition unit 62.

In this embodiment 3, the signal decomposition unit 62 decomposes the difference signal of two units of voltage signals acquired by the signal acquisition unit 61 at different times into each frequency component, and the short circuit detection unit 63 performs short circuit detection based on the results of the decomposition of the difference signal by the signal decomposition unit 62.

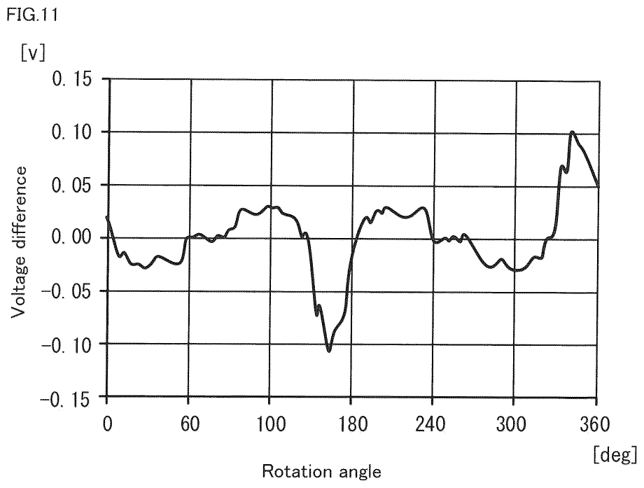

FIG. 11 is a diagram showing the difference signal between two different voltage signals acquired by the signal acquisition unit 61. This difference signal shows a voltage waveform that is the difference between the voltage signal shown in FIG. 2 (voltage waveform when normal) and the voltage signal shown in FIG. 3 (voltage waveform when short-circuited).

The signal decomposition unit 62 decomposes the difference signal of the two units of voltage signals into multiple frequency components of different orders, and further separates each of the decomposed frequency components into amplitude and phase. The amplitude of each frequency component in the difference signal indicates the amplitude change when the two units of voltage signals are frequency-decomposed.

The short-circuit detection unit 63 compares the amplitude of the odd-order harmonic components decomposed by the signal decomposition unit 62 with the amplitude of the primary frequency component.

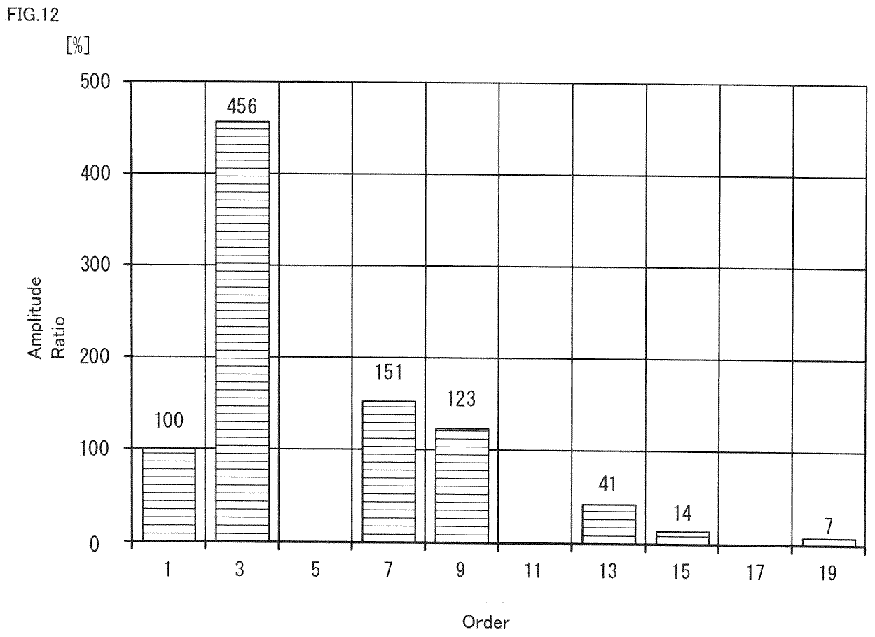

FIG. 12 is a spectrum diagram showing the amplitude ratio of each frequency component calculated by the short-circuit detection unit 63, and the ratio (%) of the amplitude of each odd-order frequency component to the amplitude of the primary frequency component is expressed as the amplitude ratio. In this case, as in the first embodiment, the fifth, eleventh, and seventeenth order components, which have relatively small absolute amplitude values, are excluded from the calculation.

If the amplitude value of the first order frequency component is Val and the amplitude value of the nth order component is Van, the amplitude ratio Ra is calculated as Ra=|Van/Va1|×100, in %.

As shown in FIG. 12, the amplitude of the third order component is significantly larger than that of the first order component.

The amplitude of each frequency component of the difference signal indicates the amplitude change of each frequency component of the two-unit voltage signal, and shows the same tendency as in FIG. 6 and FIG. 10 of the embodiments 1 and 2. That is, the amplitude of the third order component is particularly large, and the amplitude of the seventh order or higher harmonic components is small.

The short circuit detection unit 63 detects the occurrence of a short circuit in the stator core 21 based on a comparison between the amplitude of the first order component and the amplitude of the third order component, for example, when the amplitude of the third order component is clearly larger than the amplitude of the first order component.

As described above, in this embodiment, the signal decomposition unit 62 decomposes the difference signal of two units of voltage signals acquired at different times into a plurality of frequency components of different orders. The short circuit detection unit 63 then performs short circuit detection based on the result of the decomposition of the difference signal by the signal decomposition unit 62. At that time, the amplitude of the primary frequency component in the difference signal, which is the amplitude change of the primary frequency component of the two units of voltage signals, is compared with the amplitude of the low-order harmonic components in the difference signal, which is the amplitude change of the low-order harmonic components, to determine a short circuit in the stator core 21.

Therefore, as in the first embodiment, it is possible to accurately detect the occurrence of a short circuit in the stator core 21 while the turbine generator 10 is operating with the magnetic flux density of the stator core 21 being relatively high.

Furthermore, since the signal decomposition unit 62 inputs the difference signal of two units of voltage signals and performs frequency decomposition, the number of signals to be handled is halved, and the processing load is reduced.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

10 turbine generator (rotary electric machine), 20 stator, 21 stator core, 30 rotor, 50 search coil (magnetic detector), 61 signal acquisition unit, 62 signal decomposition unit, 63 short circuit detection unit, 100 short circuit detection device.

1. A short circuit detection device for a rotary electric machine comprising:
a signal acquisition circuitry acquiring a voltage signal from a magnetic detector arranged on a stator side facing a rotor of the rotary electric machine;
a signal decomposition circuitry decomposing the voltage signal into a plurality of frequency components of different orders; and
a short circuit detection circuitry determining a short circuit in a laminated stator core based on a low-order harmonic component of odd-order and a primary frequency component among the frequency component decomposed by the signal decomposition circuitry, wherein
the signal acquisition circuitry acquires the voltage signal with one electrical angle cycle as one unit;
the short circuit detection circuitry detects an amplitude change of the low-order harmonic component and the amplitude change of the primary frequency component based on two units of the voltage signal acquired at different times, and determines the short circuit in the stator core based on a comparison between the amplitude change of the low-order harmonic component and the amplitude change of the primary frequency component.

2. The short circuit detection device for the rotary electric machine according to claim 1, wherein
the short circuit detection circuitry determines that the stator core is short-circuited when the amplitude change of the low-order harmonic component is greater than the amplitude change of the primary frequency component.

3. The short circuit detection device for the rotary electric machine according to claim 1, wherein
the signal decomposition circuitry decomposes the voltage signal acquired by the signal acquisition circuitry into the plurality of frequency components of different orders, and the short circuit detection circuitry compares the amplitude change of the primary frequency component with the amplitude change of the low-order harmonic component based on the results of decomposition of the two units of the voltage signal by the signal decomposition circuitry.

4. The short circuit detection device for the rotary electric machine according to claim 1, wherein
the signal decomposition circuitry decomposes the difference signal of the two units of the voltage signal into the plurality of frequency components of different orders, and the short circuit detection circuitry compares the amplitude of the primary frequency component in the difference signal, the difference signal being the amplitude change of the primary frequency component, with the amplitude of the low-order harmonic component in the difference signal, the difference signal being the amplitude change of the low-order harmonic component, based on the result of the decomposition of the difference signal by the signal decomposition circuitry.

5. The short circuit detection device for the rotary electric machine according to claim 1, wherein
the short circuit detection circuitry uses at least one of a third order frequency component and a fifth order frequency component as the low-order harmonic component.

6. The short circuit detection device for the rotary electric machine according to claim 1, wherein
the short circuit detection circuitry calculates and uses an amplitude ratio as the amplitude change.

7. A method for detecting short circuit in a rotary electric machine, comprising:
a signal acquisition step for acquiring a voltage signal from a magnetic detector arranged on a stator side facing a rotor of the rotary electric machine;
a signal decomposition step for decomposing the voltage signal into a plurality of frequency components of different orders; and
a short circuit detection step for determining a short circuit in a laminated stator core based on a low-order harmonic component of odd-order and a primary frequency component among the frequency component decomposed in the signal decomposition step, wherein
the signal acquisition step acquires the voltage signal with one electrical angle cycle as one unit, and the short circuit detection step detects an amplitude change of the low-order harmonic component and the amplitude change of the primary frequency component based on two units of the voltage signal acquired at different times, and determines the short circuit in the stator core based on a comparison between the amplitude change of the low-order harmonic component and the amplitude change of the primary frequency component.

8/ The method for detecting short circuit in the rotary electric machine according to claim 7, wherein
the signal acquisition step repeatedly acquires the voltage signal at different times, with one electrical angle cycle as one unit, and
the short circuit detection step determines the short circuit in the stator core based on two units of the voltage signal, the previously acquired one and the currently acquired one.

9. The short circuit detection device for the rotary electric machine according to claim 2, wherein
the signal decomposition circuitry decomposes the voltage signal acquired by the signal acquisition circuitry into the plurality of frequency components of different orders, and the short circuit detection circuitry compares the amplitude change of the primary frequency component with the amplitude change of the low-order harmonic component based on the results of decomposition of the two units of the voltage signal by the signal decomposition circuitry.

10. The short circuit detection device for the rotary electric machine according to claim 2, wherein
the signal decomposition circuitry decomposes the difference signal of the two units of the voltage signal into the plurality of frequency components of different orders, and the short circuit detection circuitry compares the amplitude of the primary frequency component in the difference signal, the difference signal being the amplitude change of the primary frequency component, with the amplitude of the low-order harmonic component in the difference signal, the difference signal being the amplitude change of the low-order harmonic component, based on the result of the decomposition of the difference signal by the signal decomposition circuitry.

11. The short circuit detection device for the rotary electric machine according to claim 2, wherein
the short circuit detection circuitry uses at least one of a third order frequency component and a fifth order frequency component as the low-order harmonic component.

12. The short circuit detection device for the rotary electric machine according to claim 3, wherein
the short circuit detection circuitry uses at least one of a third order frequency component and a fifth order frequency component as the low-order harmonic component.

13. The short circuit detection device for the rotary electric machine according to claim 4, wherein
the short circuit detection circuitry uses at least one of a third order frequency component and a fifth order frequency component as the low-order harmonic component.

14. The short circuit detection device for the rotary electric machine according to claim 9, wherein
the short circuit detection circuitry uses at least one of a third order frequency component and a fifth order frequency component as the low-order harmonic component.

15. The short circuit detection device for the rotary electric machine according to claim 10, wherein
the short circuit detection circuitry uses at least one of a third order frequency component and a fifth order frequency component as the low-order harmonic component.

16. The short circuit detection device for the rotary electric machine according to claim 2, wherein
the short circuit detection circuitry calculates and uses an amplitude ratio as the amplitude change.

17. The short circuit detection device for the rotary electric machine according to claim 3, wherein
the short circuit detection circuitry calculates and uses an amplitude ratio as the amplitude change.

18. The short circuit detection device for the rotary electric machine according to claim 4, wherein
the short circuit detection circuitry calculates and uses an amplitude ratio as the amplitude change.

19. The short circuit detection device for the rotary electric machine according to claim 5, wherein
the short circuit detection circuitry calculates and uses an amplitude ratio as the amplitude change.

20. The short circuit detection device for the rotary electric machine according to claim 9, wherein
the short circuit detection circuitry calculates and uses an amplitude ratio as the amplitude change.
